(19) United States
(12) Patent Application Publication
(10) Pub. No.: US 2010/0098824 A1
(43) Pub. Date: Apr. 22, 2010

(54) APPLIANCE FOR MAKING COFFEE, TEA AND THE LIKE

(75) Inventors: Elze Deodaat Hidding, Hoogeveen (NL); Vincent Bernardus Hubertus Ten Horn, Leiden (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/443,870

(22) PCT Filed: Sep. 28, 2007
(86) PCT No.: PCT/IB2007/053945

§ 371 Date: Apr. 1, 2009

(30) Foreign Application Priority Data
Oct. 6, 2006 (EP) 06121875.6

(51) Int. Cl. A23F 5/26; A47J 31/10; A47J 31/40; A47J 31/057; A47J 31/44; A23F 3/18

(52) U.S. Cl. 426/433; 99/280; 99/320; 426/435

(57) ABSTRACT

An appliance for making coffee, tea and the like comprises a simple strength control system (20) having an adjustment unit (22) for adjusting the desired quantity ratio between the quantity of water in a water reservoir (2) and the quantity of substance in a filter holder (4). The adjustment unit (22) can adjust the water level 23 in the water reservoir (2) and the level of immersion (25) of a movable element (6) in a water reservoir (2). The water in the water reservoir exerts a buoyancy force on the movable element (6). The movable element exerts a force (21) on a lever (5). The lever (5) is balanced by a quantity of substance to be filtered in a filter holder (4) and the force (21). The strength of the brew is indicated on a strength indicating scale (10, 12, 12a, 12b).

### FIELD OF THE INVENTION

The invention relates to an appliance for making coffee, tea and the like, comprising a housing, a water reservoir, a filtering device including a filter holder, a movable element provided in the water reservoir, whose position is responsive to the level of the water in the water reservoir and a lever supported, particularly pivotally supported, by the housing and supporting the filter holder, one end of the lever being secured, particularly pivotally secured, to the movable element and a strength control system, for obtaining a desired quantity ratio between a quantity of water in the water reservoir and a quantity of substance to be filtered in the filter holder.

The invention also relates to use of such an appliance.

### BACKGROUND OF THE INVENTION

An appliance for making coffee and the like is known from U.S. Pat. No. 4,055,114. In order to obtain a good result the ratio between the amounts of water and the substance to be filtered is important. In U.S. Pat. No. 4,055,114 devices are disclosed which aim at a manner of brewing coffee and the like, in which the correct amount of substance to be filtered can be determined for any amount of water. Thereto, one of the devices of U.S. Pat. No. 4,055,114 includes a housing, a water reservoir fixed relative to the housing, a float, responsible to the water level in the water reservoir, a lever and a filtering device. An end portion of the lever is rotatably connected to the housing in a first pivot. The filtering device is rotatably suspended from the lever in a second pivot by means of bearing cams. The float is connected to the lever via a rod being rotatably attached to the lever in a third pivot. The lever, the float and the filtering device constitute a lever mechanism having a leverage ratio defined by the ratio of the distance between the first and the second pivot and the distance between the first and the third pivot. The end of the lever near the third pivot carries a pointer to indicate the position of the lever relative to the housing. Thereto, a corresponding index mark is provided to the housing. The position of the second pivot relative to the first and third pivot is adjustable. For this reason the leverage ratio of the lever mechanism is adjustable.

Depending on the desired amount of brew the water reservoir is filled to a level that is visible on a vertical scale on a wall of the reservoir. According to U.S. Pat. No. 4,055,114 the float is lifted by the water in the reservoir to a position in which the pointer is above the index mark. By pouring ground coffee into the filter holder, the lever can be returned until the pointer is at a reference mark of the index mark. The lever mechanism has been proportioned such that in this position of the lever and the pointer, a constant ratio is obtained between the amount of water in the water reservoir and the amount of ground coffee in the filter holder for any water level between a minimum and a maximum level in the reservoir. By changing or adjusting the leverage ratio the mechanism enables the preparation of a weaker or a stronger brew. An alternative way of working is mentioned, viz. to use the pointer as an indicating means for the strength of the brew.

However, the positions, where the strength control system may be provided with means for adjustment of the leverage ratio, are confined to the vicinity of the lever mechanism. The lever mechanism comprises moving parts to enable the function of constituting a filtering device. Intervening in the moving portion of the filtering device to provide a strength control system comes at the expense of a mechanism, being more complicated than required for mere realization of the filtering function.

### SUMMARY OF THE INVENTION

It is an object of the invention to provide an appliance for making coffee, tea and the like of the kind set forth in the opening paragraph, which provides a simple strength control system for obtaining a desired quantity ratio between a quantity of water in the water reservoir and a quantity of substance in the filter holder, to be filtered.

According to the invention this object is realized by an appliance for making coffee, tea and the like, comprising a housing, a water reservoir, a filtering device including a filter holder, a movable element provided in the water reservoir, whose position is responsive to the level of the water in the water reservoir and a lever supported by the housing and supporting the filter holder, one end of the lever being secured to the movable element, and a strength control system for obtaining a desired quantity ratio between a quantity of water in the water reservoir and a quantity of substance to be filtered in the filter holder, the strength control system comprising an adjustment unit for adjusting the water level of the quantity of water present in the reservoir for generating an adjusting force exerted, during use, by the movable element to the lever.

For reasons of explanation the situation is described, wherein the lever is balanced in a balanced position. In this balanced position a pointer connected to the lever is opposite to an index mark. Whenever the pointer deviates from the balanced position, extra substance may be added to or removed from the filter holder, such that the pointer is positioned opposite to the index mark again. This process will be referred to as the lever balancing process. The movable element is immersed into the water to a certain level of immersion. The movable element is secured to the lever. The level of immersion is determined by the water level of the water in the reservoir and the balanced position of the lever. The water level is adjustable by means of the adjustment unit. Consequently, the level of immersion is adjustable. The immersion of the movable element into the water causes a buoyancy force exerted by the water in the reservoir to the movable element. This buoyancy force equals the weight of the water that is displaced by the movable element. Consequently, the buoyancy force on the movable element is adjustable by the adjustment unit via the water level. Besides the buoyancy force, two more forces determine the equilibrium of the movable element, viz. a gravity force on the movable element and a lever force that is exerted by the lever to the movable element in the end of the lever, secured to the movable element. The gravity force on the movable element remains constant. Consequently, in the balanced position of the lever, the lever force is variable in dependence of the buoyancy force. The lever force causes the adjusting force as a reaction. Being the reaction force of the lever force, the adjusting force has a magnitude that is equal to the magnitude of the lever force. Consequently, the adjustment unit generates the adjusting force by adjusting the water level. The adjusting force determines the equilibrium of the lever and the amount of substance to be added to or to be removed from the filter holder. Summarizing, it may be said that, during the balancing process, the amount of substance, to be added to or to be removed from the filter holder, is adjustable via adjustment of the water level by the adjustment unit of the invention.

This is accomplished without changing the leverage ratio of the lever mechanism. The equilibrium of the lever determines the quantity ratio between the quantity of water in the water reservoir and the quantity of substance to be filtered. The strength of the brew is determined by said quantity ratio. Consequently, by adjustment of the water level, the strength of the brew is adapted without necessarily adapting the leverage ratio of the lever mechanism. Although an adjustment unit for adjustment of the water level is needed, this adjustment unit can be kept simple and no coupling to the lever and its mechanism is required. In this way a simple and reliable strength control system is obtained.

Another advantage relates to the perceived quality of the brew. If an index mark is used as a strength indication scale, it is perceived, that a unit distance on the index scale represents a strength increase of the brew that is dependent on the quantity of the water in the water reservoir and on the leverage ratio adjustment. For this reason, the user should be experienced in interpreting the position of a pointer relative to the reference mark on the index mark to obtain a brew of predictable and desired strength and differing from reference strength. To understand this difference in perception it is assumed, that the lever is balanced and the pointer is at the reference mark. The movable element is immersed into a quantity of water over a level of immersion corresponding to the reference rotation of the lever and the quantity of water in the reservoir. If an extra quantity of substance to be filtered is added to the filtering system, the filter holder exerts an extra moment to the lever. The lever rotates and the movable element is immersed deeper into the water. This process proceeds until the additional torque exerted on the lever by the weight of the extra substance is in equilibrium with the increased torque exerted on the lever by the increased buoyancy force exerted by the water on the movable element. The increase in buoyancy force is dependent of the quantity of substance to be filtered and independent of the quantity of water in the water reservoir. For this reason, the additional rotation of the lever and the pointer relative to its reference mark is determined by the weight of the substance to be filtered that was extra added to the reference quantity and not by the quantity of water. The extra-added substance may be used to strengthen a small or a large quantity of brew at the same position of the pointer relative to the index mark. By providing the movable element with a position that is responsive to the water level in the water reservoir, to the strength control system, the quantity of water in the water reservoir can be detected. The equilibrium of the lever and the strength ratio of the brew to be prepared may be set, according to the detected quantity of the water in the reservoir to obtain a strength change of the brew independent of the quantity of water in the water reservoir. In a practical embodiment the movable element may be a float.

A further advantage relates to ease of design of the appliance. The position of parts of the adjustment unit is decoupled from the specific layout of the leverage mechanism. The effects of the adjustment originate from the magnitude of the force that can be exerted to the lever by the movable element. This is quite different from influencing the equilibrium of the lever by adjusting the position of a force that is exerted to the lever as in U.S. Pat. No. 4,055,114.

A further advantage of the invention relates to the robustness of the appliance. The lever balances the quantity of the water and the quantity of substance to be filtered. As pointed out above, no position adjustment of the movable element relative to the lever is needed and the leverage ratio is unaltered, because the dimensions of the mechanism remain the same. Changing the dimensions of the leverage mechanism comes at the risk of damaging these relatively vulnerable rotating parts of the mechanism.

An advantageous embodiment of the appliance according to the invention is characterized in that the water reservoir comprises a wall and the adjustment unit comprises a movable wall portion being part of the wall of the water reservoir.

A movable wall portion enables a shape variation or adaptation of the reservoir. The shape adaptation causes an adaptation or adjustment of the water level at a fixed quantity of water in the reservoir. As explained above, the force exerted by the movable element to the lever is adjusted by the water level variation. The equilibrium of the lever mechanism is influenced by said force and the equilibrium is adjustable by said force. For this reason, the quantity ratio of substance and water is adjustable by adjustment of the shape of the water reservoir.

An advantageous embodiment of the appliance according to the invention is characterized in that the movable wall portion comprises a flexible wall portion.

A flexible wall portion is movable such that the shape of the reservoir is variable and such that the level of the water is adjustable without needing special precaution for sealing the transition between rigid and separate parts, that together constitute the wall of the reservoir. If a rigid wall is displaced relative to another wall of the reservoir, possible leakage of water from the reservoir must be prevented.

An advantageous embodiment of the appliance according to the invention is characterized in that the movable wall portion is movably connected to an adjustable element of the strength control system.

The adjustment unit may be kept very simple and comprising very few parts by directly providing an adjustable element to the movable wall portion.

An advantageous embodiment of the appliance according to the invention is characterized in that the adjustment unit comprises a movable insert adjustably positionable inside the water reservoir for inserting into the water present in the reservoir, during use.

The level of the water in the reservoir can also be advantageously adapted by inserting a body, the insert, into the water. In an embodiment the insert has a variable cross-section, whereby the level change of the water can be adjusted according to the quantity of the water in the water reservoir. By proper dimensioning of the insert, it is possible to obtain a strength variation of the brew per unit of insertion depth, independent of the quantity of the water in the reservoir.

### BRIEF DESCRIPTION OF THE DRAWINGS

These and other aspects of the appliance according to the invention will be exemplarily elucidated and described with reference to the drawings, in which:

FIG. 1 is a schematic representation of a first embodiment of the appliance according to the invention.

FIG. 2 is a schematic representation of a second embodiment of the appliance according to the invention.

FIG. 3 is a schematic representation of a third embodiment of the appliance according to the invention.

### DETAILED DESCRIPTION OF THE EMBODIMENTS

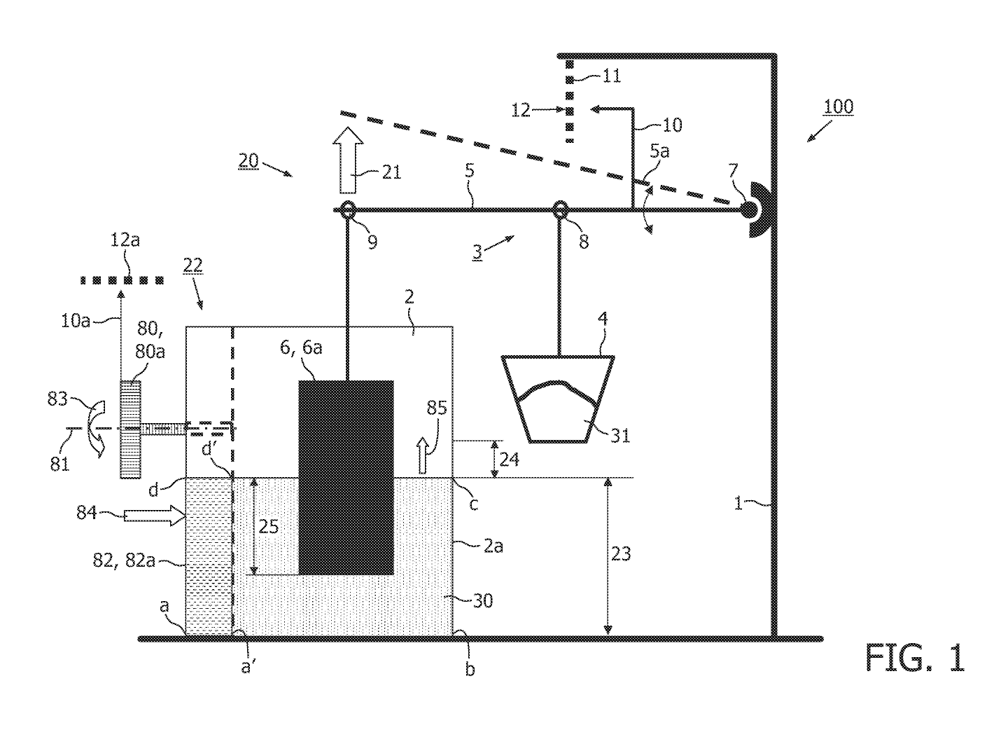

In FIG. 1 an embodiment of the appliance 100 for making coffee, tea and the like, according to the invention is schematically depicted. In this example the substance 31 is ground coffee. The embodiment according to FIG. 1 comprises a housing 1 for a water reservoir 2, a filtering device 3 including a lever 5 supported by the housing 1 and supporting a filter holder 4 for containing a quantity of coffee 31. A strength control system 20, comprising an adjustment unit 22 is provided to exert an adjusting force indicated by an arrow 21 to the lever 5. The adjusting force 21 is responsive to both a level 23 of the water 30 in the water reservoir 2 and a rotation position 5a of the lever 5. An end portion of the lever 5 is rotatably connected to the housing 1 in a first pivot 7. The filter holder 4 is rotatably suspended from the lever 5 in a second pivot 8. A movable element 6a in the form of a float 6 is provided in the reservoir 2. The water reservoir 2 has a wall 2a. The float 6 is pivotally attached to the lever 5 in a third pivot 9. The float 6 is responsive to the level 23 of the water 30 in the water reservoir 2. Depending on the water level 23 and the rotation position 5a of the lever 5, the adjusting force 21 is exerted on the lever 5. The forces acting on the float 6 are a buoyancy force exerted by the water 30 to the float 6, a gravity force on the float 6 and a lever force exerted by the lever 5 to the float 6 in the third pivot 9. In static equilibrium it follows from the equilibrium of forces acting on the float 6, that the lever force equals the buoyancy force minus the gravity force. The adjusting force 21 is the reaction force of the lever force. For this reason, the adjusting force 21 equals the gravity force minus the buoyancy force. The adjusting force 21 exerts a moment on the lever 5. Normally, the float 6 will comprise materials having a specific mass that is less than the specific mass of water. Consequently, the buoyancy force to the float 6 will be of greater magnitude that the gravity force. The adjusting force 21 will be directly upwardly as a result. The adjusting force 21 exerts a moment to the lever 5 that tends to rotate the lever 5 in a clockwise direction. A pointer 10 is attached to the lever 5. The pointer 10 moves according to the rotation of the lever 5. A strength marking scale 11 is attached to the housing 1. The position of the pointer 10 relative to the strength marking scale 11 can be adjusted by pouring additional substance to be filtered into the filter holder 4. A leverage ratio is defined by the ratio of the distance between the first pivot 7 and the second pivot 8 and the distance between the first pivot 7 and the third pivot 9. The lever mechanism and the leverage ratio are proportioned such that in the position where the pointer 10 is opposite to a reference mark 12 on the strength marking scale 11, a constant ratio is obtained between the quantity of water in the water reservoir 30 and the quantity of substance to be filtered in the filter holder 4. This ratio is independent of the quantity of water in the water reservoir 2. In this embodiment the reference mark 12 on the strength marking scale 11 should be interpreted as a set point while dosing coffee to the appliance; when the pointer 10 is opposite to the reference mark 12, the right quantity of coffee is added to the filter holder 4. The strength marking scale 11 is not to be interpreted as a strength indicating scale, comprising strength units to indicate the strength of the brew to be obtained. In the embodiment of FIG. 1 an extra adjustable spring (not indicated in FIG. 1) may be added for exerting a force to the lever to tare the weight of the lever 5 and components attached thereto and to adjust the position where the pointer 10 is opposite to a set point or mark on the strength marking scale 11 (not indicated in FIG. 1).

The wall 2a of the reservoir 2 comprises a movable wall portion 82a. In this embodiment, the movable wall portion 82a is a flexible wall portion 82. An adjustable element 80a in the form of an adjustment knob 80, included by the adjustment unit 22, is rotatably connected to the flexible wall portion 82. The adjustment knob 80 has a length axis 81. A rotation 83 around length axis 81 of the adjustment knob 80 causes a translation 84 of the flexible wall 82. Transmission of a rotation into a translation is generally known per se and is not described here. The flexible wall portion 82 has an old position as indicated by point a and point d. After adjustment of the flexible wall 82 its position is indicated by points a′ en d′. As a result of the adjustment of the flexible wall portion 82, water in the reservoir 2 is pushed away and causes a rise 85 of the water level 23. As a result the level of immersion, indicated by an arrow 25, of float 6 increases. The buoyancy force exerted by the water to float 6 is dependent on the level of immersion 25 of float 6 and increases also. The increase in buoyancy force is part of the adjusting force 21 and transmitted to the lever 5. The lever 5 rotates until a new position 5a is reached. To balance the lever such that the pointer 10 is positioned opposite to the reference mark 12, more coffee has to be added. Thus, the strength of the obtained brew will increase. The rise 85 of the water level 23 causes an increase of the water level 23 of magnitude 24. The magnitude 24 is proportional to the original water level 23 if the area of the cross-section of the water reservoir 2 is constant. For this reason, the desired quantity ratio and the perceived strength increase of the brew are dependent on the rotation 83 and translation 84 of the flexible wall portion 82 and independent on the quantity of water in the reservoir 2. For this reason, a strength indicating scale 12a, possibly including strength units, is provided to the housing 1 and a pointer 10a is attached to the adjustment knob 80. In the embodiment of FIG. 1 the outside limitation of the reservoir are comprised by the adjustment unit 22. It is also possible to adjust an inner limitation of the reservoir 2. Adjustment of an inner limitation of the reservoir 2 also falls within the scope of the present invention.

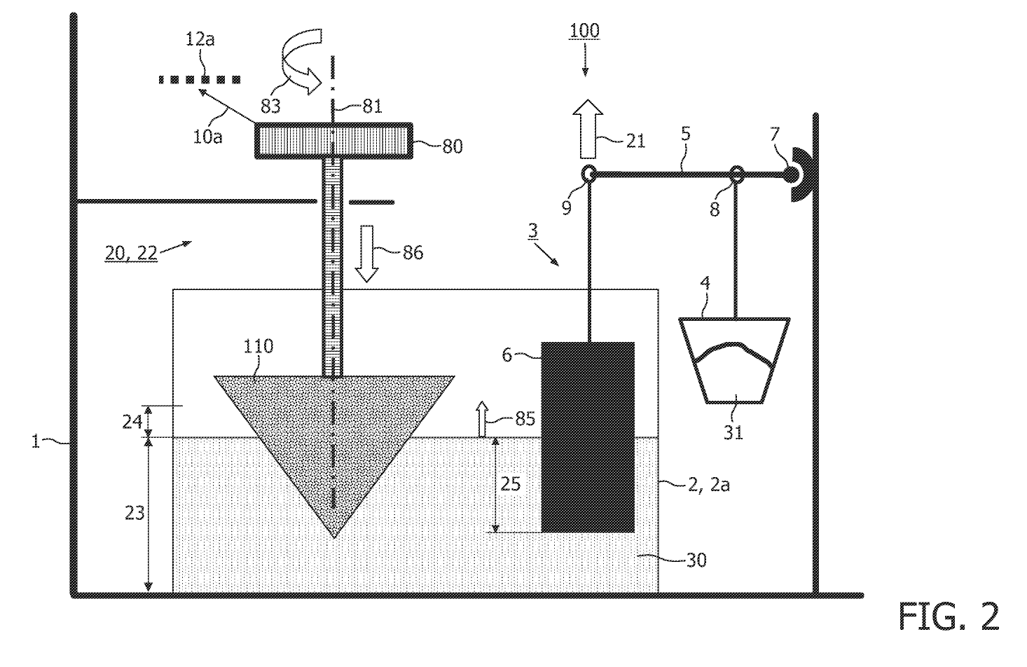

FIG. 2 is a schematic representation of another embodiment of the appliance 100 according to the invention. The same reference signs are used for those components that are similar to the corresponding component in the embodiment of FIG. 1. In FIG. 2 an adjustment knob 80 is attached to an insert 110. The adjustment knob 80 and the insert 110 have a length axis 81. A rotation 83 of the adjustment knob 80 causes a translation 86 of the adjustment knob 80 and the insert 110. Transmission of a rotation into a translation is generally known per se and not described here. As a result of the translation 86, the insert 110 is immersed deeper into the water 30 in a water reservoir 2. By the insertion of the insert 110, water is pushed aside and a water level 23 starts to rise. A rise 85 of the water level 23 has a magnitude 24. The insert 110 is of e.g. a conical shape. The area of a cross-section perpendicular to the length axis 81 increases if the cross-section is closer to the adjustment knob 80. For this reason, the magnitude 24 of the rise 85 per unit of insertion depth of the insert 110 is dependent on the level 23. The ratio behind the design of the cross-section of the insert 110 is to obtain a magnitude 24 per unit of insertion depth of insert 110 that is proportional to the level 23 of the water in the reservoir 2. The immersion 25 of a float 6 into the water 30 causes an increase in the buoyancy force on a float 6. After balancing a lever 5 by adding substance to a filter holder 4 as described according to FIG. 1, the perceived increase in strength of the brew is independent of the water level 23. As in the embodiment of

FIG. 1, pointers and scales can be provided to an adjustment unit 22 and the lever 5.

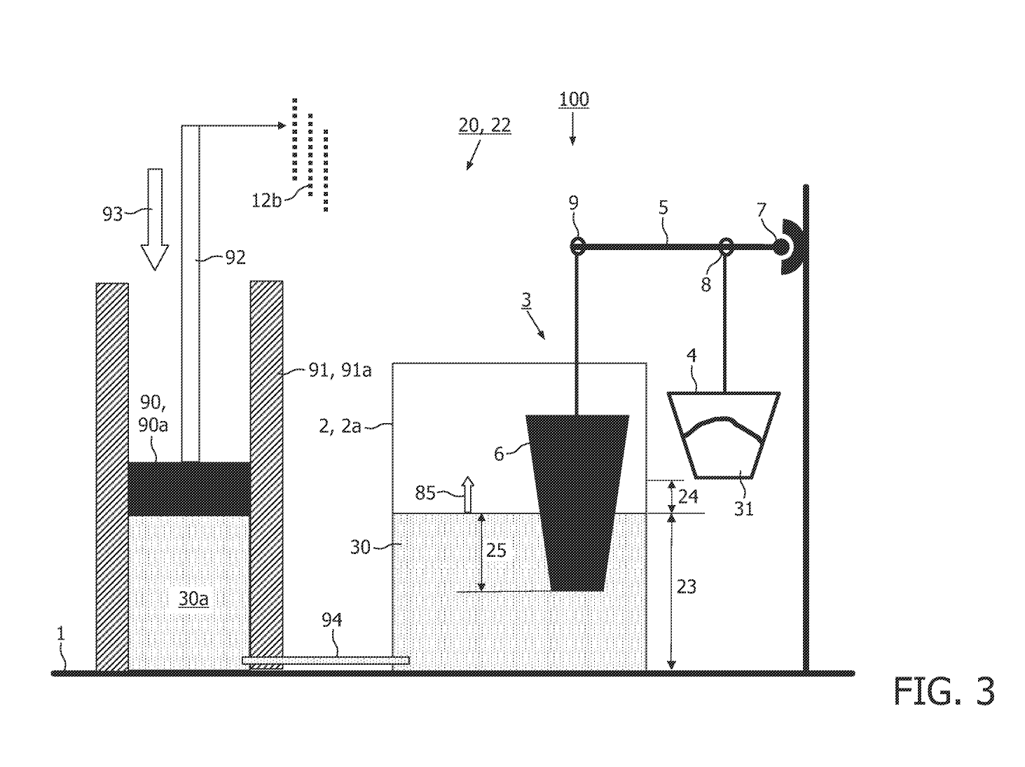

FIG. 3 is a schematic representation of yet another embodiment of the appliance 100 according to the invention. The same reference signs are used for those components that are similar to the corresponding component in the embodiments of FIGS. 1 and 2. In FIG. 3 a vessel 91a comprises a quantity of water 30a. An adjustable boundary 90a seals the vessel 91a and enables adjustment of the quantity of water 30a comprised by a separate vessel 91a. In a practical and preferred embodiment the adjustable boundary 90a may be a piston 90 and the separate vessel 91a may be a cylinder 91. The water quantity 30a is adjusted by a translation 93 of a rod 92. The position of the rod 92 is indicated relative to a multi scale 12b. A connection in the form of e.g. a water hose 94 enables the communication between the cylinder 91 and a water reservoir 2. The water reservoir 2 accommodates a float 6. A translation 93 of the rod 92 and the piston 90 displaces a corresponding quantity of water 30a comprised by the cylinder 91. As a result a level 23 of the water in the reservoir 2 rises. The magnitude 24 of the rise 85 of the level 23 of the water 30 is dependent on the translation 93. In this example the float 6 is of variable cross-section, whereby the magnitude 24 is also dependent on the level 23 of the water. The ratio behind the design of adjustment unit 22 and the shape of the float 6 is to obtain an increase in the buoyancy force on the float 6 that is proportional to the level 23. In the case that the float 6 has a substantially constant cross-section, the position of the rod 92 can be indicated relative to a multi scale 12b. The multi scale 12b comprises several scales corresponding to the level 23 of the water in the reservoir 2, e.g. a first scale for less than 2 cups of coffee, a second scale for less than 4 cups of coffee and a third scale for a larger quantity of coffee. A pointer 10, a reference mark 12 and a strength marking scale 11 as indicated in FIG. 1 for the dosing process of the substance are not indicated in FIG. 3, but such a pointer system can be used in this embodiment of FIG. 3. To avoid enclosure of air in the vessel 91a or in the cylinder 91, an automatic de-aeration device (not shown in FIG. 3) may be provided to the vessel 91 a or cylinder 91. Such a device is generally known per se and not described here. Alternatively, the assembly of the adjustable boundary 90a and the separate vessel 91a may be positioned below the water reservoir 2 as a means for de-aeration of the separate vessel 91a.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. Devices, elements and components, known per se, have not been described in detail, as the skilled person is familiar with the matter. In the claims, the word “comprising” does not exclude other elements or steps, and the indefinite article “a” or “an” does not exclude a plurality. A single mechanism or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. An appliance (100) for making coffee, tea and the like, comprising:
a housing (1),
a water reservoir (2),
a filtering device (3) including a filter holder (4), a movable element (6) provided in the water reservoir (2), whose position is responsive to the level of the water in the water reservoir (2) and a lever (5) supported by the housing (1) and supporting the filter holder (4), one end of the lever (5) being secured to the movable element (6), and
a strength control system (20) for obtaining a desired quantity ratio between a quantity of water in the water reservoir (2) and a quantity of substance to be filtered in the filter holder (4), the strength control system (20) comprising an adjustment unit (22) for adjusting the water level of the quantity of water present in the reservoir (2) for generating an adjusting force (21) exerted, during use, by the movable element (6) to the lever (5).

2. An appliance (100) according to claim 1, wherein the water reservoir (2) comprises a wall (2a) and wherein the adjustment unit (22) comprises a movable wall portion (82a) being part of the wall (2a) of the water reservoir (2).

3. An appliance (100) according to claim 2, wherein the movable wall portion (82a) comprises a flexible wall portion (82).

4. An appliance (100) according to claim 2, wherein the movable wall portion (82a) is movably connected to an adjustable element (80, 80a) of the strength control system (20).

5. An appliance (100) according to claim 1, wherein the adjustment unit (22) comprises a movable insert (110) adjustably positionable inside the water reservoir (2) for inserting into the water present in the reservoir (2) during use.

6. An appliance (100) according to claim 1, wherein the adjustment unit (22) comprises a separate vessel (91a) being in communication with the water reservoir (2) and having an adjustable boundary (90a).

7. An appliance (100) according to claim 6, wherein the separate vessel (91a) comprises a cylinder (91) and the adjustable boundary (90a) is part of a piston (90).

8. An appliance (100) according to claim 1, wherein the adjustment unit (22) includes an indicator (10, 12, 12a, 12b) for indicating a ratio between the quantity of water in the water reservoir (2) and the quantity of substance to be filtered in the filter holder (4).

9. Use of the appliance (100) as claimed in claim 1.
